(19) United States
(12) Patent Application Publication
(10) Pub. No.: US 2010/0242672 A1
(43) Pub. Date: Sep. 30, 2010

(54) Method and device for self-contained inertial vehicular propulsion

(76) Inventor: Gottfried J. Gutsche, Mississauga (CA)

Correspondence Address: G. Gutsche, 6816 Estoril Rd., Mississauga, ON, L5N1N1, CA

(21) Appl. No.: 12/802,388

(22) Filed: Jun. 7, 2010

Related U.S. Application Data
(63) Continuation-in-part of application No. 11/544,722, filed on Nov. 29, 2006.

(51) Int. Cl. F16H 33/08

(52) U.S. Cl. 74/84 R

(57) ABSTRACT

Self-contained timely sequential inertial thrust drive pulses are generated by a tandem mechanical frequency modulated oscillator using the combined effort of linear and rotational inertial reluctance contained in the mass of paired flywheels. The flywheels are having parallel axial orientation with linear displaceable spacing, opposite free wheeling rotation and opposite alternate cyclic machine-logic optimized non-uniform reciprocal motion in union with vehicular travel direction. The combined effort of linear and rotational flywheel motion accomplishes the cyclic realignment of the flywheel motion into one timely gradient vector sum motivating thrust drive. A flywheel integral regenerative drive and rotor within each flywheel are used to obtain the cycle frequency modulation and non-uniform motions. The cyclic sum of all mutual reciprocal mass motion energy transactions represents a closed loop complex Cartesian grid motion with one self-contained superior centripetal inertial thrust drives pulse per each rotor cycle.

This is a Continuation-in-part (C.I.P) specification for original application Ser. No. 11/544,722

### FIELD OF THE INVENTION

The present invention relates to a device and method for developing a self-contained timely sequential potential energy work output thrust drive in a predetermined direction, using the combined effort of rotational and linear kinetic energy of pairs of flywheel inertial mass motions, wherein the flywheel kinetic energy is provided by regenerative drive means under control of machine logic. The effective work output thrust drive is the product of potential energy performing work multiplied by the time duration of the motion and then dividing the product by the motion distance. The effective thrust drive magnitude, when considering the magnitude of the inertial mass, is the square root out of the product of the averaging constant multiplied by the inertial mass then multiplied by the magnitude of the potential kinetic energy performing work on the mass.

### BACKGROUND OF THE INVENTION

The earliest example of using the combined effort of rotational and linear kinetic energy to produce a large linear potential energy work output thrust is the carriage mounted medieval catapult called “Trebuchet”. The action of this catapult was up to 30% more effective than fixed catapults because of the combined (simultaneous) effort of linear and rotational kinetic energy. The “Trebuchet” was also the first device to generate such a large linear work output by accelerating a rotational rotor mass within less than one half revolution of the rotational motion. The combined linear and rotational motion of this catapult has similarities to the present invention where the projectile of the Trebuchet becomes the body of the device and the carriage is operating within the device.

A further prior art of the present invention are the experimental clocks placed on ships in the 18^{th} century when clockmaker attempted to build clocks capable of sustaining the local time of Greenwich England for longitude navigation. Clockmakers were confronted by an intriguing problem. It seems, no matter how ingenious such clocks were devised they either advanced or retarded in comparison to the Greenwich time, which of course means the clocks gained kinetic energy or depleted kinetic energy. It was determined that the complex motion of the ships was causing the change in clock kinetic energy. How can we explain such a true phenomena with Newton's equal reaction to an action? How can an action of the isolated system of a ship react on the kinetic energy of a clock on the same ship without direct transmission connections? Since the ship to clock energy transfer relationship is a documented reality, then it can be argued with accuracy: Because of the reversibility of physics principles, energy and impulse must be continuously transferable from large clocks mounted within ships in a reversed process motivating ships travel motion.

One of the first successful use of the flywheel for powering vehicular motion was for a public transportation bus called the “Gyrobus” engineered by the Swiss Orlekon company. The reason for the reasonable success of the Gyrobus was the large kinetic storage capacity of the used flywheel having a large diameter and high RPM rotational speed. The gyrobus only required 1/100 of the Gyrobus high flywheel kinetic energy to power one start motion of the bus from a stop position up to the city speed limit. The reduction from the high speed RPM flywheel rotational motion to the relative low travel speed of the bus was accomplished with an electrical transmission apparatus. This principle illustrates the profound difference of high kinetic energy transaction through transmission to direct impulse and momentum transaction of colliding masses.

Previous known art of self contained inertial propulsion devices using independent linear moving flywheels or other inertia elements develop comparatively low energy propulsion thrusts or high degree of vibration compared to the energy input and size of the machines. The thrust output of these type of inertia drives can be improved with machine logic optimisation of the linear flywheel movement eliminating the need for additional inertial mass displacements carried by the flywheels. The machine logic optimisation allow the device to respond to a changing gravitational load environment as encountered in the pendulum test. The previous technologies lack the use of logic timed alternating energy flow of motor-generators to generate an unimpeded reciprocal motor-generator to flywheel torque in an advantageous thrust vector projection. In addition, the use of flywheels with integral motor-generators combined with a central-shaft mounted rotational-to-reciprocating transmission is also a new development in the field. Reciprocal opposing alternating linear flywheels movement working in a pair has the advantage of minimising vibrations caused by the moving masses and allows for a more continuous form of propulsion thrust.

### BRIEF SUMMARY OF THE INVENTION

It is the objective of the present invention to provide a self contained inertial propulsion device with directional control.

It is another objective of the invention to provide an inertial propulsion device with a high degree of efficiency.

It is still another objective of the invention to provide an inertial propulsion device with a low vibration characteristic.

It is a further objective of the invention to use advanced motor control and engineering techniques for the advancement of inertial vehicular propulsion.

Other features and advantages will be apparent from the following description with accompanying drawings.

### DESCRIPTION OF THE DRAWINGS

FIG. 1 is the top view of the mechanical representation of the propulsion device. The format is in wire-frame format for unimpeded logical perusal.

FIG. 2 is the side view of the propulsion device.

FIG. 3 is the propulsion device having a fluid motor-pump as a regenerative drive means

FIG. 4A is the propulsion device employing mechanical transmission and a continuous running drive motor as the kinetic energy source.

FIG. 4B is the side view of the buffer and clutch means.

FIG. 5 is the graphical representation of the motor-generator drive pulses generated by the logic control.

FIG. 6 is the graphical representation of the motor-generator rotor angular speed progression.

FIG. 7 is the graphical representation of the resultant potential energy work output thrust pulses.

FIG. 8 is the graphical representation of the mechanical work output thrust vector flows.

FIG. 9 is the propulsion device operating with a complimentary cam and cam follower.

### DETAILED DESCRIPTION OF THE PREFERRED EMBODIMENT

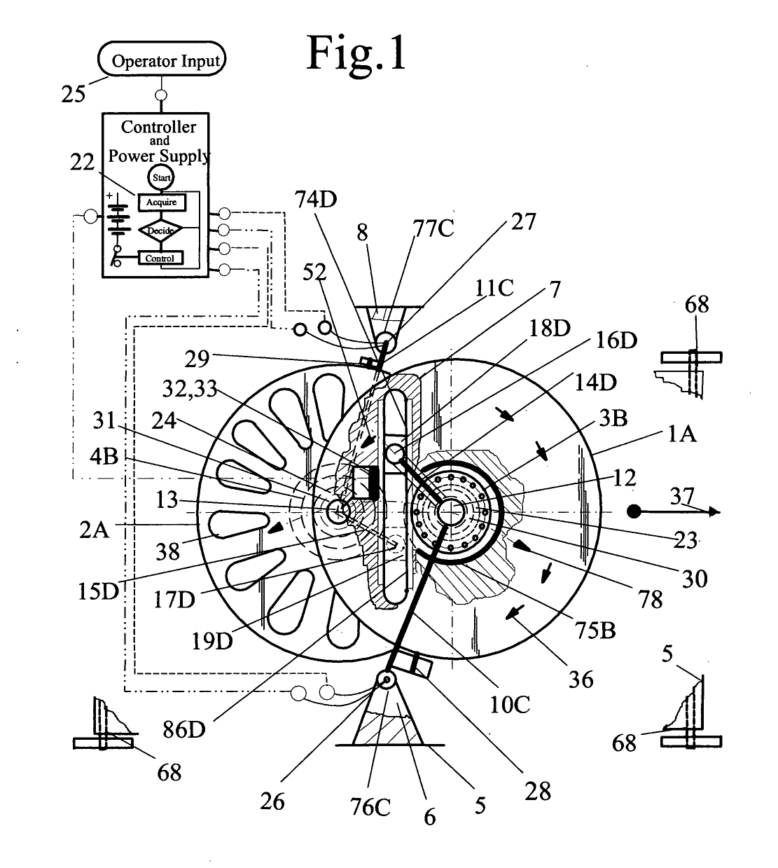

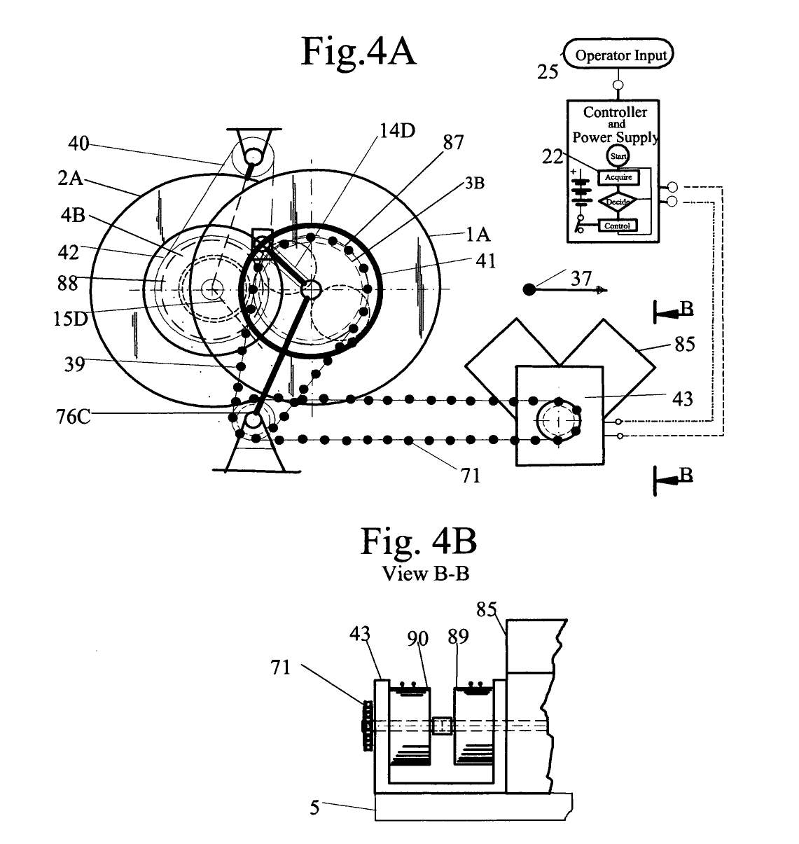

Referring to FIG. 1, the self-contained propulsion device comprising pairs of flywheels, 1A and 2A, having parallel axial orientation and linear displaceable axial spacing. Each individual flywheel of the flywheel pair, in comparison to each other axis, have a linear mutual separating motion 78 followed by a re-approaching motion 78 and opposite direction of rotation 36, therefore, the linear motion of the flywheel pair is a kinetic energy dependent mutual time sequential diametrically opposing alternating linear motion. The linear and rotational motion of the flywheels are progressively changing non-uniform movements which accomplishes the net potential energy work output propulsion thrust drive propelling the vehicles' (68) motion. The opposite direction of flywheel rotation accomplishes the cancellation of rotational torque, which prevents the turning of the device around its axis. The turning action, however, is used to steer the device by varying the rotational parameters of the flywheel drives. Each flywheels 1A and 2A contain a substantially embedded regenerative drive means b-group comprising motor-generator rotor 3B, 4B and field magnets 75B. The motor generator rotor has the dual purpose of delivering directional alternating torque and accumulating rotational kinetic energy. The torque delivered by the regenerative drive is mutually reciprocally applied to the flywheel and reciprocally to the motor-generator rotor. The group members of the regenerative drive means 3B, 4B,75B and the flywheels 1A, 2A each are combining their inertial masses forming integral flywheel assemblies AB-group. For operational consideration the total inertial mass of each flywheel assembly is determining the magnitude of the linear motion work output thrust pulses while the rotational mass moment of inertia of the flywheel 1A,2A and the rotor 3B,4B determine the rotational torque pulses. The regenerative drive means B-group can be of different types of technologies, for example, a fluid motor-pump such as a pneumatic vane motor-pump or a hydraulic gear motor-pump. In FIG. 1, for illustration and operational presentation an electrical motor-generator rotor 3B,4B with the current carrying conductors and field magnets 75B is shown. The side-wall of the flywheel 1A, is cut open to reveal the motor-generator within the flywheel. The motor-generator B-group supplies regenerative kinetic energy pulses to the flywheel assemblies, causing the flywheel rotation and the regenerative motor-generator rotor causes the progressively changing alternating non-uniform linear flywheel assembly movement. The progressively changing non-uniform linear and rotational flywheel assembly motions is the source of dynamic inertial mass back-rest for the unimpeded self-contained exertion of the kinetic propulsion energy, which is fully explained in FIGS. 4,5,6,7. The operation of an inertial mass backrest can be understood as similar as to the inertial mass backrest used in sheet metal rivetting operation which prevents the deformation of the sheet metal. The reason that the riveting is not deforming the sheet metal while applying an substantial inertial mass backrest against the metal surface is that the rivetting kinetic energy of the rivetting impact hammer is distributed according to the reverse ratio of the impact hammer mass to the inertial backrest inertial mass. This means that the substantial inertial backrest receives very little kinetic energy and the rivetting hammer receives a large amount of rebound kinetic energy. Accordingly, in analogy of the presented propulsion device, during the driving of the regenerative drive, the rotor 3B receives a large amount of rotational kinetic energy and the larger inertial mass of the flywheel 1A receives a small amount of kinetic energy. Furthermore, the flywheel linear motion in relation to the device motion relates to the same reverse ratio of masses: The large mass of the device receives a small amount of kinetic energy and the small mass of the flywheel receives a large amount of kinetic energy. For ease of viewing, the supporting frame 5 of the propulsion device is cut away from the attachment point 6,7,8,9 for unimpeded view of the active working elements. The propulsion device further comprises two guidance means c-group comprising members 10C,11C,64C,65C,76C,77C which provide each flywheel assembly with substantial linear freedom of movement 78 in vehicular travel direction 37. For the present embodiment, swing-arms 10C and 11C are depicted providing linear guidance, but many other technologies are suitable to guide the flywheels in linear motion.

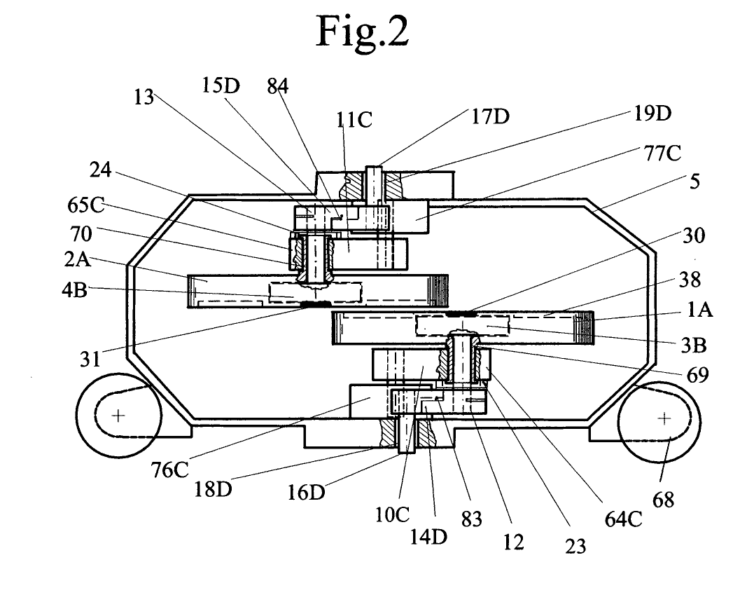

Referring to FIG. 2, which depicts the side view of the propulsion device within the complete supporting frame. The side view of the propulsion device reveals the flywheels 1A and 2A, the guidance means 10C and 11C and the motor-generator encoder 30 and 31.

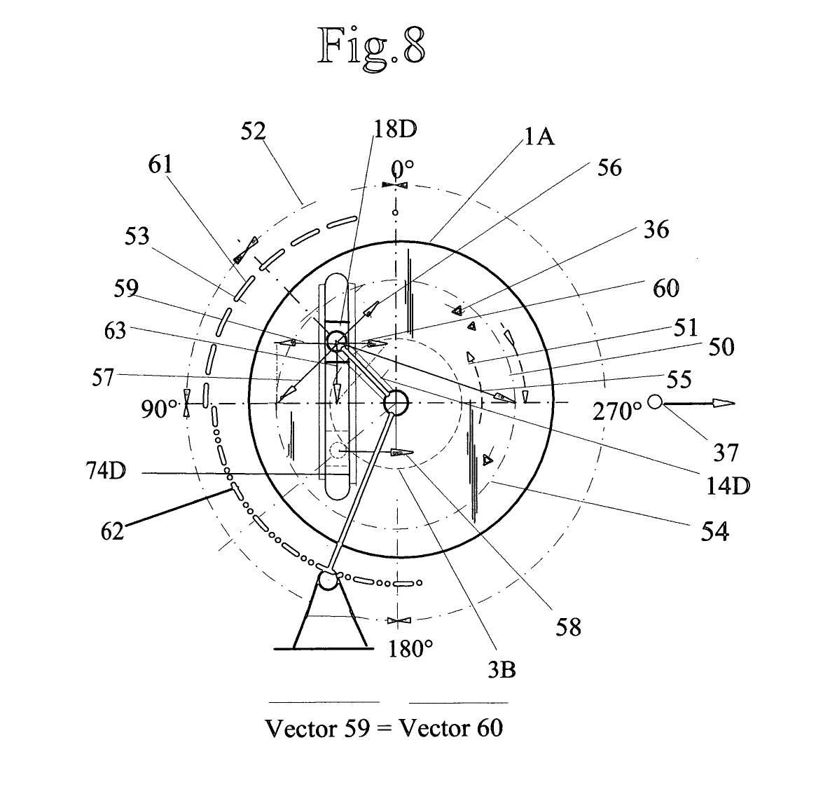

Referring to FIG. 1 and FIG. 2, the swing-arms 10C,11C have a wrist-end linear movable member 64C and 65C. The swing-arms pivot at the socket-end fixed member pivot block 76C and 77C. The flywheels 1A and 2A are rotatably contained on the wrist-end movable member 64C and 65C by rotational bearing 69 and 70. The flywheels 1A and 2A rotate around the central shaft 12 and 13, by means of rotational bearings 69 and 70, while the integral motor-generator rotor 3B,4B is secured co-centrically onto the central shafts 12 and 13. The central shaft is rotatably contained on the wrist-end movable member 64C,65C by means of the rotational bearing 69 and 70. Each flywheel assembly AB-group further comprises a rotational-to-reciprocating transmission means D-group comprising members 14D,15D, 16D, 17D,18D,19D, 74D and 86D for motivating each flywheel assembly in individual reciprocating linear motions. The minimum functional members of a rotational-to-reciprocating transmission is a rotational input and a reciprocating output, however, because the central shaft is driven by a regenerative drive means supplying power as well as receiving power, accordingly, each input and output member of the rotational-to-reciprocating transmission must be considered an input/output. The flywheel assembly linear inertial mass motion consists of two kinetic energy distributing starting motions and two kinetic energy conserving stopping motions for every 360° rotation of the motor-generator rotor. Each individual flywheel assembly linear starting and stopping inertial mass motion has its own individual thrust magnitude depending on each initial potential kinetic energy magnitudes. The initial rotational kinetic energy potential of the rotor is determining the thrust magnitude for the starting motion and the flywheel assembly linear kinetic potential energy is determines the thrust magnitude for each stopping motion. The net propulsion thrust magnitude is also in direct analogy with the average angular speed of the motor-generator rotor during the flywheel assembly starting motion, the higher the average rotor angular speed performing the starting motion, the higher the propulsion thrust, up to a maximum of 33% angular speed gradient of the peak angular rotor speed. When kinetic energy is removed during the starting motion by energizing the motor-generator rotor with a negative drive, then there is a mutual reciprocal torque between the rotor and the flywheel slowing the angular speed of the rotor, slowing the flywheel rotation and slowing the linear starting motion of the flywheel assembly. When new energy is induced during the stopping motion part it will not change the effective thrust magnitude of the stopping motion because all linear motion energy of the flywheel assembly is conserved in the rotation of the motor-generator rotor. This principle will be discussed with vectors in FIG. 8. The rotational-to-reciprocating transmissions comprising an radius bar members 14D and 15D secured eccentrically onto each central shaft 12,13. The eccentric end of the radius bar members have the wrist-pins 16D and 17D secured in a radius length from the central shaft, thereby, the wrist pins are performing an orbital motion 52 around the central shaft 12,13. The wrist pins 16D and 17D are rotatably contained in the linear bearings blocks 18D and 19D. The linear bearing blocks 18D and 19D, are linearly displaceably retained in the supporting frame 5, perpendicular to the flywheels axis and central to the guidance means. Thereby, because the wrist pin having an orbital motion 52 around the central shaft, the central shaft and the flywheel assembly mounted upon it performs a substantial reciprocating motion. The central shafts 12,13 are rotatably driven by the regenerative motor-generator rotor 3B,4B having input as well as output power, therefore considering the operational aspects of the device, the central shaft 12,13 which is secured to the radius bar members 14D, 15D represent a rotational input/output member. The movable member 64C,65C together with the flywheel assembly 1A,2A represents a reciprocating member and the wrist-pins 16D,17D together with the linear bearings blocks 18D,19D working against the working surface 74D represent the kinetic energy output path into the vehicle 68. The summing points of motivating kinetic propulsion energy and contrary kinetic energy occurs in the bearing block 18D,19D working against the working surface 74D. It is important that there is a single kinetic energy summing point and energy entrance point into the vehicle for verifications of operational performance. A further improvement to the radius bar member is the variation of the length of the radius bar members 14D,15D on the track 83,84 for maximising the propulsion thrust in consideration of the stencil strength of the construction materials. Many technologies are available to motivate the flywheel assemblies reciprocally from a rotational input, the present invention is not limited to the one particular motion technology presented. The propulsion device further comprises a power-supply and a logic control means 22, which contains the machine logic control that times and maximises the efficiency of the working components from information emitted from sensors. The logic control means function is a mature technology readily assembled from off the shelf components, for example a PLC latter logic controller or a single chip micro-controller having fuzzy logic. The subject of the present invention is the unique component combination and the operational method of sequential control. In the drawings, a dashed line is for the power flow connections and a dash dot dot line is for sensor information from sensors 28-33. For the simplest form of the device, manually adjustable power commutators 23 and 24 mounted to the central shafts 12, 13 are able to supply timed power drive pulses to the motor-generators. The logic control means has an operator command and control input 25 for setting speed and directional control of the vehicle 68. The method of directional control is accomplished with the differential variation of the duration and angle parameters of the motor-generator drive pulses. Power commutator 26 and control commutator 27, pass power and control information from the logic control to the flywheel assemblies. The rotational position and angular speed of the flywheels 1A and 2A, are emitted by the encoder 28 and 29. The rotational position and angular speed of the motor-generator rotors is emitted by encoder 30 and 31. The drive pressure exerted by the bearings blocks 18D and 19D, is emitted by the pressure sensors 32 and 33. The directional arrow 36, indicates the continuous rotational direction of the flywheels, which is indicated in clockwise direction but can be in counter-clockwise direction, which then reverses all other directions including the propulsion direction. The directional arrow 37, indicates direction of vehicular travel. The imbedded electromagnetic poles 38, imbedded in the sidewalls of the flywheel 1A and 2A, are used for absorbing excess rotational and linear kinetic energy from the flywheels 1A and 2A The action of the imbedded electromagnetic poles 38, acting mutually reciprocally between flywheels 1A and 2A, has no negative influence on the output thrust drive and returns excess kinetic energy of the flywheels 1A and 2A, back to the power-supply 22.

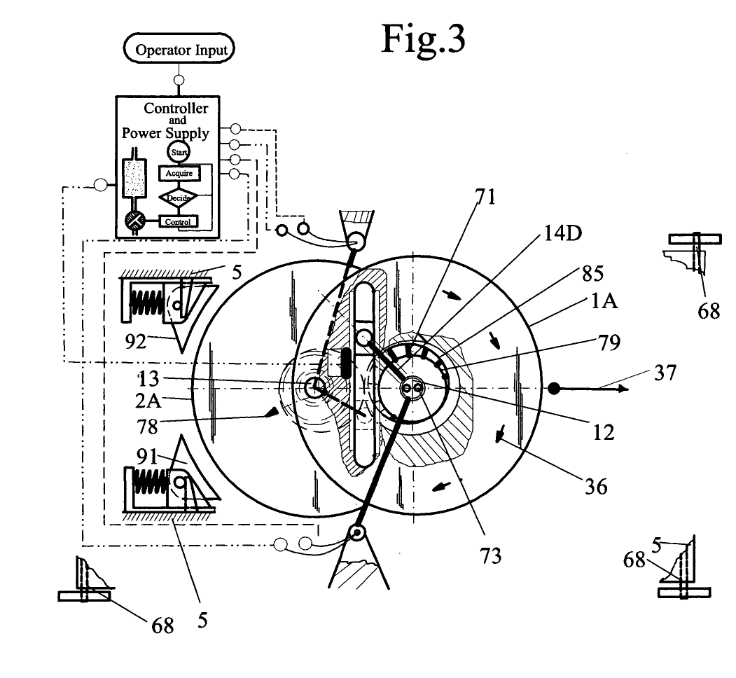

Referring to FIG. 3, which depict the propulsion device using a fluid motor-pump 71 as regenerative drive means. The body 85 of the fluid motor-pump is ex-centric to the central shaft 12 and drivingly secured to the radius bar member 14D. The rotor 79 is secured to the central shaft 12 and driving the flywheel 1A mutually reciprocally to the radius bar member 14D. Fluid power is supplied through supply passages 73 in the central shaft 12. Furthermore, a variation to the function of the imbedded poles 38 in FIG. 1 is the use of frictional touch break shoes 91 and 92 for absorbing excess kinetic energy from the flywheels 1A and 2A. The break action of each touch break shoe is timely sequential, occurring at the end of each flywheel motion in opposite direction of vehicular travel direction 37.

Referring to FIG. 4A, which depicts the top view of the propulsion device with a mechanical rotational transmission means 39 and 40, for supplying rotational kinetic energy to the flywheels 1A and 2A through the supply wheel 87,88. The differential transmission means 41,42, distributes the rotational kinetic energy into the central shaft 12,13, into the radius bar members 14D,15D and into the rotor 3B,4B, and mutual reciprocally into the flywheels 1A and 2A. The timing, clutch and buffer means 43, times and buffers the rotational kinetic energy flow to the flywheels 1A and 2A under control of the logic control means 22.

Referring to FIG. 4B, the side view of the timing clutch and buffer means. The clutch 89 is typically an electromagnetic powder type clutch and the buffer 90 is typically an electromagnetic powder type mechanical break. The torque delivered by these kind of devices is proportional to the DC input current allowing the torque to be controlled by the logic control means 22. The mechanical components are off the shelf available stock drive technologies. This arrangement allows for the use of a continuous running drive motor, typically an internal combustion motor.

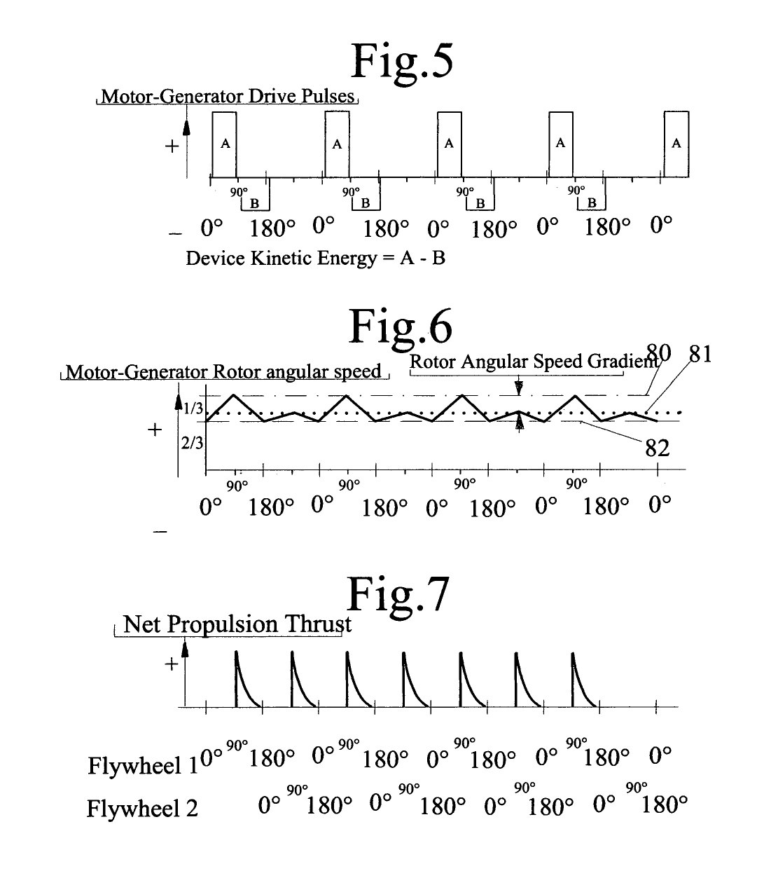

Referring now to FIG. 5, which depicts the graph of the motor-generator alternating energy drive pulses in relation to the angular motion 52 of the rotor 3b in FIG. 1. The graph depicts the energy drive pulses for the motor-generator rotor 3B generated by the logic control means to subsequently accomplish an optimum potential energy work output thrust. The motor-generator rotor positive drive pulses start at 20° and end at 90°, which drives and accelerates the flywheel 1A in the clockwise direction and drives mutually reciprocal the motor-generator rotor 3B in the counter-clockwise direction. Applying the principle of kinetic energy distribution of mutually separating masses accordingly inducing rotational kinetic energy into the rotor. In FIG. 1, the position of the motor-generator rotor 3B indicated by the radius bar member 14D is shown at 45°, while 0° is at the position of the radius bar member 14D at 12 o'clock position and is the start of the flywheel assembly linear stopping motion in direction of vehicular motion 37. During the angular acceleration of the motor-generator rotor 3B while passing from 20° to 90° accumulates rotational kinetic energy into the motor-generator rotor 3B subsequently used for the propulsion thrust, which is called accumulation phase.

Referring to FIG. 6, at the end of the accumulation phase at 90° the motor-generator rotor 3B has the highest rotational kinetic energy potential 80 within the total propulsion cycle duration of 360° and is the beginning of the flywheel assembly starting motion in opposite direction of vehicular travel 37. The propulsion thrust phase is accomplished by the angular de-acceleration of flywheel 1A and the mutual reciprocal de-acceleration of the motor-generator rotor 3B, creating an additional angular speed gradient (80 minus 81) in the rotor. The propulsion thrust phase drives the motor-generator with a negative drive pulse and is an on demand quantity depending on the gravitational and frictional load on the vehicle 68. The vehicle gravitational load is determined by the control means 22 data collected from the encoders 28,29,30,31. The propulsion thrust phase occurs between 90°-190°, which accelerates the linear inertia of the flywheels assemblies opposite of vehicular travel direction 37 employing the higher initial rotor kinetic energy potential 80 present at 90°. The thrust phase is driving the vehicle forward in a mutual reciprocal mass motion separation between the flywheel assembly inertial mass and the vehicle inertial mass, distributing the accumulated rotor kinetic energy between the vehicle and the flywheel assembly according to the reverse ratio of the separating inertial masses. The drive-phase effectively converts and depletes the high rotational kinetic energy of the motor-generator rotor 80 into linear kinetic energy of the vehicle (68). The drive phase also restores any unused kinetic energy back into the power-supply during a stall condition. The motor-generator negative drive phase power has always a lower intensity than the positive power accumulation phase because of frictional losses, sufficient kinetic energy must remain in the motor-generator rotor 3B, to complete the rotational cycle at the regular angular speed 81. When disregarding frictional losses, the difference between the accumulation phase drive power and the propulsion phase negative drive power is the kinetic energy invested into the motion of the device.

Referring now to FIG. 7, which depicts a graph of the typical resulting potential energy work output thrust drive generated by the pairs of flywheels 1A and 2A. The output thrust drive, starts to develop from the inertia elements during the propulsion thrust phase, past 90°; when the combined linear inertial reluctance of the flywheel assembly and the accumulated rotational kinetic energy of the motor-generator rotor, invest kinetic energy into the forward motion of the vehicle (68). The angular speed gradient is the peak angular speed 80 at 90° minus the regular angular speed 81 at 270°. The maximum ratio between the peak angular speed 80 and the lowest angular speed 82 should be a ratio smaller than 1 to ⅔ or less than 1.5 decimal, any greater ratio is an effort of diminishing returns. The logic control means keeps the speed gradient (80-81) constant by applying sufficient negative power drive pulses, thereby keeping the propulsion thrust constant under changing gravitational load conditions. The difference between the regular angular speed 81 and the lowest angular speed 82 is inversely proportional to the mass moment of inertia of the rotor, the higher the mass moment of inertia of the rotor the lower the difference between 81 and 82. Then, solving effective potential energy work output thrust in regards to rotor angular speed, the effective average (mean value) propulsion thrust developed between 90° and 190° is equal to ½ the flywheel assembly inertial mass times the radius bar 14D effective orbital radius times the rotor angular speedgradient. (magnitude of 80 minus magnitude of 81). Furthermore, when considering frictional losses from rotor rotation 180° to 0°, friction is reducing the effective propulsion thrust and must be subtracted from the rotor angular speed gradient. The magnitude of 80 minus magnitude of 81 minus any loss of angular rotor speed due to friction from 180° to 0° is the true effective angular speed gradient performing the propulsion thrust.

Referring now to FIG. 8, which depicts the vector parameters in correlation to the angular rotation of the motor-generator rotor 3B. The directional arrow 50, indicates the angular acceleration of the flywheel 1a. The directional arrow 36, indicates the continuous rotational direction of the flywheel, which is in a clockwise direction. The directional arrow 51, indicates the de-acceleration direction of the flywheel. The rotational direction 52, indicates the rotation of the motor-generator rotor 3B. The vector angle 53, between the position of the radius bar member 14D and the right angle of the linear bearing 18D, determines the instantaneous acceleration/de-acceleration characteristic of the flywheel assembly liner inertia, following a progressive changing no-uniform sinusoidal motion. The centre line of mass moment of inertia is indicated with dashed circle 54. The vector triangle 55, is the instantaneous representation of the vector thrust drive, for the indicated vector angle 53. The motor-generator rotor torque, acting against the reluctance of the flywheel rotational inertia, generates the reciprocal tangential thrust drive vector couples 56 and 57, thrust drive vector 58, is the main driving thrust for the inertial propulsion device during the drive phase 62. The tangential vector 57, generated between 20-90° is the main source of kinetic energy for the self-contained inertial propulsion device and is unimpeded because its energy is generated mutual reciprocal between the motor generator rotor and the flywheel. The kinetic energy is accumulated from 20°-90° in the motor generator rotors rotational inertia and is called the accumulation phase 61. The accumulated kinetic energy is then released during the kinetic energy drive phase 62, from 90-230°. The accumulated kinetic energy is used to accelerate the linear inertia of the flywheel assemblies, in opposite direction of vehicular travel, accordingly investing net linear kinetic energy into the vehicle in direction of vehicular travel by applying force vector 58 against working surface 74D, driving the vehicle forward. The excess linear kinetic energy induced into the flywheel assembly during this reciprocal action is then absorbed by the imbedded electromechanical poles, between 180° and 270°, preventing a loss of forward drive for the reversal of alternating motion. This method of self contained inertial propulsion depicted in FIG. 8, therefore becomes apparent, because the thrust drive vectors 59 and 60 are opposing, neutralising the main source moment of thrust drive tangential vector 57, for any reaction drive thrust opposite of vehicular travel direction; the thrust drive vector 57 is, at the same time, inducing rotational kinetic energy into the motor-generator rotor at an ever increasing rate, causing the kinetic energy accumulation phase 61. The reason that the main source moment of potential energy work output thrust drive is not acting as an opposing thrust to vehicular travel, is the increasing linear de-acceleration rate of the flywheel assemblies linear inertia, up to the reversal of the flywheel assemblies linear sinusoidal movement at 90°. The de-acceleration represented by thrust drive triangle 55, generates thrust drive vector 63, which generates thrust drive vector 60, which opposes thrust drive vector 59. During the accumulation phase, the progressive increasing linear de-acceleration of the flywheel assembly's linear inertia acts as a governing influence, returning any increase in linear kinetic energy instantaneously back into the rotational energy of the motor-generator rotor, which represents a governing negative feedback loop.

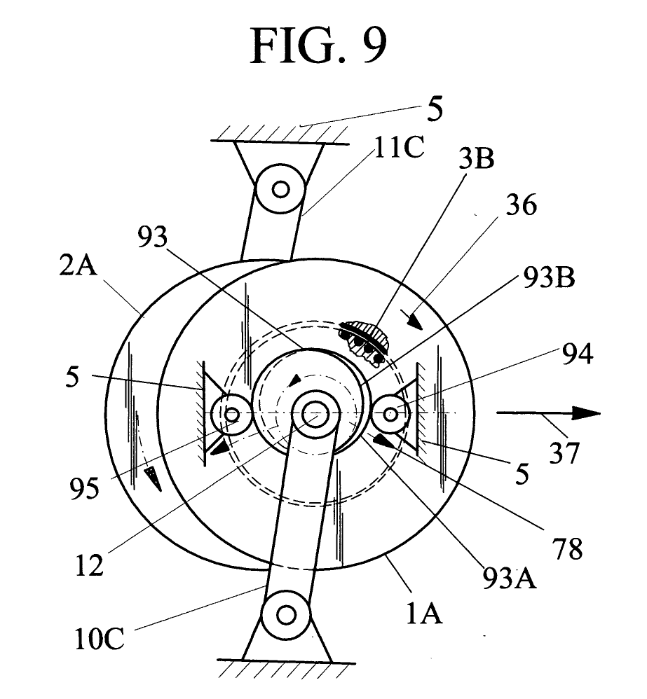

Referring to FIG. 9 wherein the propulsion device is depicted having a rotational-to-reciprocating transmission means comprising a cam 93 mounted onto the central shaft 12 and cam followers 94, 95 mounted onto the frame 5. This arrangement is performing the reciprocating motion of the flywheel 1A. The cam 93 is having two complementary ex-centric angular surfaces 93A and 93B guided by the two cam followers 94 and 95, arranged in such a way, to guide the flywheel 1A in reciprocating motion direction 78.

While I have shown and described a preferred embodiment of my invention, if will be apparent to those skilled in the art that many changes and modifications may be made without departing from my invention in its broader aspect. I therefore, intend the appended claims to cover all such changes and modifications as fall within the true spirit and scope of my invention.

I claim:

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. A device for self-contained vehicular timely sequential inertial propulsion thrust in a predetermined direction comprising:
A frame (5) having freedom of vehicular (68) motion in vehicular travel direction (37);
one or preferably multiple pairs of flywheels (1A,2A) having parallel axial orientation, displaceable axial spacing and perpendicular axial orientation to the said vehicular travel direction, each flywheel having a body and a substantial inertial mass and opposing direction of rotation (36); the device further including
a linear guidance means (C-group) for guiding each said flywheel independently including
a fixed member (76C,77C) having a guidance surface mounted within the said frame with an guidance orientation in union with vehicular motion direction (37) and located adjacent to each other, further having
an associated guided longitudinal displaceable member (64C,65C) having freedom of motion (78) in mutually diametrically opposing alternating longitudinal motion (78) in relation to each said displaceable member; each said displaceable member including a rotatably mounted shaft (12,13) rotatably and co-centrically disposed into the said flywheel; the device further comprising
regenerative drive means (b-group) for providing a motive and a regenerative power source having
a housing body (1A,2A) disposed co-centrically and preferably sharing the said flywheel body, the regenerative drive means further including
a rotor (3B,4B) having preferably a smaller inertial mass than the flywheel secured co-centrically onto the said shaft, the said housing body including inner peripheral surface mounted pole members (75B) for exerting a torque for turning the rotor and mutually reciprocally turning the said flywheel;
a power-supply (22) having preferably a large storage capacity of energy for supplying power to the said regenerative drive means; the device is further comprising
an encoder (30,31) mounted onto the said longitudinal displaceable members and engaged with the said shaft to emit cyclic start, position, cycle time and angular speed signals per revolution of the shaft and
an encoder (28,29) mounted on the said longitudinal displaceable member and engaged with the said flywheel to emit the angular speed of the flywheel;
a logic control means (22e) for controlling the said regenerative drive means by making machine logic decisions further including the devices' optimum operational control sequence, having a command input (25) from an operator source and receiving cyclic timing input from the said encoder and further having
a switch-able connection from the said power supply to the said regenerative drive means for switching energetic positive and negative polarity drive pulses for driving the said rotor in
an non-uniform angular speed; each said flywheel is further having
a plurality of means (38) for absorbing excess rotational kinetic energy from the said flywheels, mounted in such a way onto each flywheel or alternately disposed onto the said frame in such a way to absorb the kinetic energy from the flywheels without translational motion interference to the flywheel and dispose the excess kinetic energy into heat or to return the energy back into the aid power-supply; the aggregate inertial masses of each said shaft, the said flywheel, the said regenerative drive means, the said rotor and the said longitudinal displaceable member combine to operate as
a flywheel assembly having a substantial inertial mass and having the said freedom of translational motion for the exertion of the said propulsion thrust; each flywheel assembly is having an associated
translational kinetic energy output member (74D,86D) mounted within the said frame in proximity with each said guidance means having a work surface (74d,86D) oriented in such a way to accept translational kinetic energy into the said frame in union with said vehicular travel direction; each said flywheel assembly is having an associated
rotational-to-reciprocating transmission means (d-group) for providing the said flywheel assembly with the said translational motions having
a rotational input/output member (12,13), further having a rotational to translational drivingly coupled
reciprocating member (64C,65C) and is further having
a kinetic energy output path (12-14D-16D-18D-74D, 13-15D-17D-19D-86D) rotational to translational drivingly coupled to the said working surface of the said kinetic energy output member for converting said non-uniform angular speed of the said rotor into cyclic reciprocating non-uniform translational motions of the flywheel assembly and mutual reciprocally into the said propulsion of the device.

27. A method for generating a self contained timely sequential directional propulsion thrust within a vehicle having substantial mass,
wherein the method employing longitudinal displaceable flywheels operating in pairs with parallel axial orientation, displaceable axial spacing and perpendicular axial orientation to the said directional propulsion thrust, each said flywheel is operating in non-uniform reciprocal translational motion opposite each other for the exertion of the said propulsion thrust against the said device body and operate in opposing direction of rotation between each other flywheel for canceling motion dependent impulses and further having a substantial inertial mass which is preferably distributed in such a way to deliver the maximum possible rotational kinetic energy storage capacity and relative minimum translational kinetic energy storage capacity for absorbing angular impulses reciprocally, operating according to a (#1) working principle of kinetic energy distribution relative to the reverse ratio of the inertial masses and Newton's first law; each flywheel is set in motion by the torque of
a regenerative drive in a regenerative power mode contained co-centrically within the flywheel body, the power torque of the regenerative drive is mutually reciprocally turning
a rotor by exerting against the flywheel having preferably a smaller inertial mass than the flywheel, the power torque is mutually reciprocally accumulating rotational kinetic energy into, or depleting energy from, the rotor substantially unimpeded from any impulse exertions against the said frame because of a working principle of (#2) of kinetic energy distribution relative to the reverse ratio of the mass moment of inertia and Newton's first law; the regenerative drive is controlled by
a logic control, making machine logic decisions including the regenerative drive optimum operational control sequence, receiving command input from an operator source and receiving cyclic timing, speed and force input from a rotor encoder, flywheel encoder and a propulsion force sensor furthermore switching
a switch-able connection from a power supply to the regenerative drive, switching progressively non-uniformly timely dispensed energetic positive and a negative polarity drive pulse per one half revolution of the shaft providing the said torque, the positive drive pulse accumulates rotational kinetic energy into the rotor for providing the propulsion thrust motive power, the negative drive pulse is withdrawing rotational kinetic energy from the rotor having a gravitational and resistive load depending timely dispensed magnitude in such a way to remove excess power and for locking the kinetic propulsion drive energy into the device body, the difference between positive and negative drive pulse energy is the device body kinetic energy gain in the said propulsion direction per rotor rotation having a working (#3) principle of kinetic energy conservation applying to Newton's first law, thereby the said rotor is having a substantially progressively non-uniformly cyclic gradient rotational kinetic energy with one superior (80) event and two identical (82) repeating events of potential rotational kinetic energy magnitudes per revolution of the shaft and preferably maximum of 33% cyclic gradient, exceedingly progressive non-uniform angular speed; the said logic control further controlling
a plurality of means for absorbing excess rotational kinetic energy from the said flywheels, mounted and timed in such a way onto each flywheel or disposed onto the frame in such a way to absorb the kinetic energy reciprocally between flywheels without translational motion interference to the flywheel assembly and dispose into heat or regenerative recapture the energy, having a working principle of (#4) mutual conservation of kinetic energy based on Newton's first law; the inertial masses of flywheel and the regenerative drive are operating as
a flywheel assembly inertial mass having a substantial combined inertial mass and having freedom of translational motion for the exertion of the said propulsion thrust; having a working (#5) principle of mutual reciprocal kinetic energy distribution between the device body and the flywheel assembly translational kinetic energy; each flywheel assembly inertial mass is receiving the said translational reciprocating motion with a motion length through a
rotational-to-reciprocating transmission receiving input power torque from the rotor; the method further employing
a kinetic energy output path rotational to translational drivingly coupled from the said rotor to a work surface of the said device body accordingly converting the said cyclic changing rotational kinetic energy of the rotor into cyclic reciprocating non-uniform translational motions of the flywheel assembly and mutually reciprocally into motions of the device body in union with the said propulsion thrust direction, the cyclic reciprocating translational motions are having
two starting motion parts,
two stopping motion parts,
two momentary events of cyclic repeating identical translational kinetic energy (82) with maximum momentary translational speed magnitudes in coincident with the beginning of
each stopping motion parts,
each said translational motion part is having
a motion length is preferably less than the rotor radius and is exerting mutual reciprocal translational thrust between the flywheel assembly inertial mass and the device body inertial mass,
one translational stopping motion is in union with propulsion thrust direction, having coincidence with the said positive drive pulse and is having simultaneous mutual reciprocal identical translational thrust exertion between the flywheel assembly and the translational working surface, further having coincident with the said mutual reciprocal torque exertions between rotor and the flywheel rotation having a (#7) working principle of rotor kinetic energy accumulation (61), kinetic energy distribution and kinetic energy conservation based on Newton's first law,
the rotor angular motion and the flywheel assembly translational reciprocating motions performing combined
three motion parts having initial conditions with identical potential kinetic energy (81,82) magnitudes and
one starting motion part contrary to the propulsion thrust direction which is coinciding with an initial condition of the said superior (80) rotor kinetic energy and coinciding with the said on demand dispensed negative drive pulse exerting mutually reciprocally between the translational working surface and the flywheel assembly a timely superior (#8) non-uniform potential energy work output thrust drive in union with propulsion thrust direction, the rotational-to-reciprocating transmission further operating with
a negative feedback loop having a working (#9) principle of kinetic energy conservation during the energetic mutual reciprocal separating of the said flywheel assembly and the method is having a timely sequential potential energy work output thrust, distributing the available potential kinetic energy of the said rotor according to the reverse ratio of device body mass to the said flywheel assembly mass, the principle of progressively non-uniform mass motion thrust, all based on (#10) Newton's first law, operating with
a reciprocal differential feed path from the rotational-to-reciprocating transmission to the said translational working surface for reciprocally feeding and reducing the said cyclic non-uniform rotational kinetic energy magnitude of the rotor into the translational kinetic energy of the flywheel assembly, and for cyclic feeding and depleting to zero all translational kinetic energy potential of the flywheel assembly into the rotational kinetic energy of the rotor, each feeding is preserving the kinetic energy magnitude of the preceding mass motion part in a reciprocating cycle according to the working principle (#9,#10), the kinetic energy work output thrust exerted against the said translational working surface by each kinetic energy feed is the square root out of π/2 times the kinetic energy feed magnitude times the flywheel assembly mass, accordingly, solving the kinetic energy work output thrust in view of the work performed by the rotor, the effective net kinetic energy work output thrust is then the said flywheel assembly mass times the said motion length times the said superior angular rotor speed (80) minus the regular angular rotor speed (81); the device method of operation in short summary is:
the said generative drive power turns the said rotor with angular work by exerting angular mutual reciprocal work against the said flywheel which energizes the rotor with the said substantially progressively cyclic changing unimpeded rotor rotational kinetic energy potentials, subsequently, using the accumulated rotational kinetic energy potential of the rotor, as an initial condition and timely dispensing the said on demand negative power drive pulse energy and feeding the result into the said rotational-to-reciprocating transmission mutually reciprocally motivating the said shaft including the flywheel assembly and the device body translational and directionally dependant non-uniformly up to the magnitude of the repeating maximum translational speed event 80, causing directional gradient timely sequential dispensed magnitudes of potential energy work output thrust in said direction of propulsion,
the method steps comprising:
the said rotor having a rotation direction arbitrary chosen at counter clockwise, choosing a clockwise rotor rotation would change all subsequent rotation directions in the method;
the rotor rotation is divided into 360° for analysis purposes, all timing references are approximates;
the rotor position zero° is at the end of the flywheel assembly's translational starting motion in union with the propulsion direction;
the method steps for zero net propulsion thrust magnitude in idle mode for each 360° of rotor rotation is the regular rotor angular speed (81) and the minimum rotor angular speed (82) occurring alternatively every 90° of the rotor rotation, for propelling the vehicle the method step for rotor rotation from 0° to 90° is performing the step,
the logic control using the sensor input and is sensing the history of the two cyclic repeating lowest rotor angular speed magnitudes (82) comparing the value with the desired said operator input value and is energizing the said regenerative drive with a positive drive pulse magnitude to accomplish the operator input desired cyclic regular angular speed (81) and the desired device body speed; the positive drive pulse is having preferable a rising slope progression delivering the maximum drive at 90° during the least translational motion speed of the flywheel assembly,
the said positive drive pulse turns the rotor and the shaft with the angular power by exerting angular power mutual reciprocally against the flywheel according to the principle of kinetic energy doing work mutually reciprocally on the inertial masses employing the formula,
the flywheel mass moment of inertia divided by the rotor mass moment of inertia is equal to the rotor kinetic energy divided by the flywheel assembly translational kinetic energy,
the method step from 0° to 90° is accumulating (61) additional rotational kinetic energy provided by the positive energy drive pulse into the rotor without affecting the inertia of the device body because of a mutual conservation of kinetic energy action of the flywheel assembly with the rotor there is no translational reaction of the device body and further that any new translational kinetic energy feed through the said negative feed back loop from 0° to 90° will be instantaneous feed back into the rotor and is accumulated (60),
the cyclic event of superior (80) rotor kinetic energy having an angular speed of the square root out of two times the kinetic energy divided by the mass moment of inertia of the rotor, subsequently,
the rotor rotational kinetic energy accumulated during 0° to 90° is used subsequently as an initial motion start condition blending timely the said on demand dispensed negative power drive pulse energy and feeding them into the rotational-to-reciprocal transmission motivating the said shaft including the flywheel assembly translational and non-uniformly up to the cyclic repeating identical flywheel assembly translational velocity according to the following formulas and steps, converting the rotor total accumulated rotor kinetic energy to a rotor angular speed magnitude using the formula,
the said superior (80) rotor angular speed event at 90° is equal to the square root from two times
the total accumulated kinetic energy divided by the rotor mass moment of inertia,
the method step from 90° to 180° comprising
calculating the effective propulsion thrust dispensed from 90° to 180°,
the propulsion thrust is ½ the flywheel assembly mass times the flywheel assembly start motion length times the difference between the magnitude of the superior (80) rotor angular speed minus the magnitude of the regular (81) identical rotor angular speed event.
the logic control makes comparison decisions starting at 100° based on the history of the relative angular rotor speed comparing 180°-90° with 90°-180° determining the magnitude of the kinetic energy reciprocally dispensed into the device body by the propulsion thrust, if there is insufficient kinetic energy dispensed due to a gravitational load, the logic control is dispensing an increase in the negative drive pulse energy accordingly, keeping the angular speed gradient of the rotor (80 minus 81) constant thereby keeping the propulsion thrust constant including during a stall condition,
the propulsion thrust drive is having a net effective timely sequential thrust in relation to the total cycle time duration of 360° because the progressively non-uniform rotation of the rotor is exerting a mutual reciprocal progressively non-uniform mass motion acceleration in exponential relation to the average rotor angular speed from 90°-180°, while the total time duration of the 360° cycle is the 2 times pi divided by the average angular speed of the rotor, accordingly, the net propulsion thrust is directly proportional to the magnitude of the superior rotor angular speed event (80), the higher the superior angular rotor speed (80) the proportionally higher is the propulsion thrust.

28. A device as claimed in claim 26, in which the rotational-to-reciprocating transmission means comprises
an radius bar member (14D,15D) having a length and two ends, where the first end is secured onto the said shaft (12,13) which is the said rotational input/output member; and the second end has
a wrist pin (16D,17D) secured onto it, the wrist pins are rotatably contained in the linear bearings blocks (18D,19D), the linear bearing blocks are longitudinally displaceable retained in the said frame perpendicular to the said flywheels axis and central to the said guidance means, the said wrist pins exerting against the said bearing blocks further exerting against the working surface (74D) further exerting against the said frame which represent the said kinetic energy output path, the said wrist pin having an orbital motion (52) around the said central shaft, the central shaft and the said flywheel assembly mounted upon it performs a substantial longitudinal reciprocating motion and is the said reciprocating member (64C,65C).

29. A device as claimed in claim 26 in which the said regenerative drive means comprises an electrical motor-generator.

30. A device as claimed in claim 26 in which the said regenerative drive means comprises a fluid motor-pump (71).

31. A device as claimed in claim 26 in which the rotational-to-reciprocating means further comprising
a radius bar member (14D,15D) having a length, in which the length is adjustable on tracks (83,84) to make the said reciprocal motion length of the said flywheel assembly selectable for maximizing the said propulsion thrust in relation to the stencil strength of the construction material

32. A device as claimed in claim 26 further comprising
a power-commutator (23,24) mounted onto each said shaft, for timing the said drive pulses.

33. A device as claimed in claim 26 in which the said translational kinetic energy output member further includes
a pressure sensor for sensing the instantaneous forward propulsion thrust for input into the logic control means.

35. A device as claimed in claim 26, in which the said logic control means further comprises a command and control input (25) for speed and directional control of the device by selecting the timing and the power levels of the said drive pulses of each said regenerative drive means differentially.

36. A device as claimed in claim 26, in which each linear guidance means (C-group) comprises
a pivot block (76,77) representing the said fixed member; and the said longitudinal displaceable member is represented by the swing arm (10C,11C) having a length with two ends, the first end is a socket-end pivotally contained on the said pivot block and the second end is the longitudinal displaceable member (64C,65C), thereby the wrist-end displaceable member (64C,65C) having substantial longitudinal freedom of motion.

37. A device as claimed in claim 26, in which the said logic control means comprises a computer ladder logic controller.

38. A device as claimed in claim 26, in which the said logic control means comprises an integrated circuit logic controller.

39. A device as claimed in claim 26 in which the said logic control means comprises a power commutator (23,24) for timing the said drive pulses.

40. A device as clamed in claim 26 in which the said plurality of means for absorbing excess rotational kinetic energy (38) from the flywheels comprises
a plurality of electromagnetic poles imbedded into each said flywheel side-wall, facing each flywheel in close proximity, timely absorbing rotational kinetic energy from the said flywheels reciprocally without interference to the said flywheel assembly translational motions and having the ability to return the energy back into the said power-supply under the control of the said logic control means.

41. A device as claimed in claim 26, in which the said plurality of means for absorbing excess rotational kinetic energy are frictional touch break shoes (91,92)

42. A device as claimed in claim 26, in which the regenerative drive means comprising
a continuous running motor (85) for supplying mechanical work;
a timing clutch buffer (43), receiving mechanical work from the said motor and delivering timed kinetic energy drive pulses according to the said logic control means;
a differential transmission (41,42) having
an input and
two differential outputs, the input is drivingly engaged with
a kinetic energy supply wheel (83,84), the first output is drivingly engaged with the said flywheel, the second output is drivingly engaged with the said shaft, further comprising
a chain drive (39,40,71) mounted centrally onto each said fixed members (76C,77C) for transmitting the said timed kinetic energy drive pulses from the said timing clutch buffer to the said kinetic energy supply wheel, the inertial mass of the said flywheel and the said differential transmission combine to form combining to form an operational integral flywheel assembly having a substantial inertial mass for delivering the said propulsion thrust.

43. A device as claimed in claim 26 in which the rotational-to-reciprocating transmission means comprising
a cam (93) mounted onto the shaft (12) and
cam followers (94, 95) mounted onto the frame (5); the said cam is having
two complementary ex-centric angular surfaces (93A, 93B) guided by the said two cam followers, arranged in such a way, to guide the flywheel (1A) in reciprocating motion direction (78).
